(19) United States
(12) Patent Application Publication
(10) Pub. No.: US 2007/0260396 A1
(43) Pub. Date: Nov. 8, 2007

(54) GPS navigation enhanced system

(75) Inventor: Kevin Hsu, Pan Chiao City (TW)

Correspondence Address: TROXELL LAW OFFICE PLLC;SUITE 1404, 5205 LEESBURG PIKE, FALLS CHURCH, VA, 22041, US

(73) Assignee: Galips Technology Corporation

(21) Appl. No.: 11/416,233

(22) Filed: May 3, 2006

(51) Int. Cl. G01C 21/00

(52) U.S. Cl. 701/213; 701/200

(57) ABSTRACT

The present invention relates to a GPS navigation system by enhancing the current navigation device. More particularly, a map-containing navigation device and a GPS receiver can be separately positioned in the GPS navigation system of the present invention. A virtual machine of the GPS receiver is utilized to operate the map-containing navigation device using multiple GPS receivers simultaneously. Further, each target can be positioned and displayed on the map. The general navigation system, therefore, can be further expanded for tracing and positioning the targets.

### CROSS-REFERENCE TO RELATED APPLICATION

Not Applicable

### STATEMENT REGARDING FEDERALLY SPONSORED RESEARCH OR DEVELOPMENT

Not Applicable

### FIELD OF THE INVENTION

The present invention relates to a GPS navigation system. More particularly, a map-containing navigation device and a GPS receiver can be separately positioned in the GPS navigation system of the present invention. A virtual machine of the GPS receiver is utilized to operate the map-containing navigation device used in multiple GPS receivers simultaneously. Further, each target can be positioned on the map for another application besides the navigation purpose.

### BACKGROUND OF THE INVENTION

The global positioning system (GPS) is widely developed and applied for decades. The areas of the applications are wide, such as meteorology, aviation, military, agriculture, traffic, and etc. The current GPS is a satellite navigation system set by Department of Defense (D. O. D.) of U.S.A. The system mainly comprises: 1. Space satellite segment, 2. Ground control segment and 3. User receiver segment.

In the space satellite segment of the GPS, multiple satellites in different orbits are operated individually in the periphery of the earth. Moreover, each satellite uses a wireless radio method to continuously transmit the relative information for the receiver on earth. In the ground control segment, several units are set for tracing and controlling the satellite. The user receiver segment is mostly closed to users for general use. The theory of the user receiver segment is that the receiver receives the GPS information and obtains the position, speed, heading, time, date . . . etc messages after calculation. Further, the longitude/latitude coordinates of the receiver on the earth plane can be confirmed.

In the commercial area of the practice, “in-car GPS navigation system” is a common technique in the GPS area. As can be known, the in-car GPS navigation system is one of the navigation systems using the positioning function of GPS by coordinates accompanying the map information.

Please refer to FIG. 4 and FIG. 5. The figures are two conventional uses. FIG. 4 shows a block diagram reactive between the GPS receiver and the map-containing navigation device. FIG. 5 is a diagram showing the theory of the conventional navigation device. The method is to combine a GPS receiver and a navigation device with detailed map-containing information. Moreover, the coordinate information can be received in the GPS receiver and sent to on the map of the navigation device. Therefore, the car according the coordinates from the displayed position on the map can be guided toward to the destination. The detailed theory can be seen in FIG. 5, and no description is necessary to be addressed here.

There are several disadvantages for the traditional satellite navigation system as follows:

1. One navigation device should exist when one GPS receiver is set. Besides, the navigation device and GPS receiver should exist at the same time for use.

2. Every map-containing navigation device only can work for one GPS receiver.

3. The information should be received by GPS and transmitted to the navigation device for obtaining the positioning and navigation functions.

4. The conventional system can not recognize or control multiple positioned targets.

5. Every set of the GPS receiver and the navigation device should have one set of map-containing information.

6. The installation cost is high and the applicable area is limited.

According to the above descriptions, the traditional satellite navigation system is always limited on navigating application. The inventor, based on the experiences in the wireless, communication, electronics and IT business, is to propose the present invention in this patent application. The theory is that the signals for multiple targets received in the GPS receiver are transmitted to the main control center. The main control center can trace, position, display, and guide the multiple targets simultaneously as a satellite trace control system.

### SUMMARY OF THE INVENTION

The present invention relates to a GPS navigation system which enhances and expands the current navigation device for further application. More particularly, a map-containing navigation device and a GPS receiver can be separately positioned in the GPS navigation system of the present invention. A virtual machine of the GPS receiver is utilized to operate the map-containing navigation device using in multiple GPS receivers simultaneously. Further, each target can be positioned and displayed on the map. The general navigation system, therefore, can be further expanded for tracing and positioning the targets.

Each target has a GPS receiver. The received signal is transmitted to the control center thru wireless radio. By launching the virtual machine of the GPS receiver, a set of the map-containing navigation device is used in multiple GPS receivers simultaneously. More, the position of each target can be pointed in the map for various applications, such as fleet management, vehicle tracking and positioning.

Please refer to FIG. 1 and FIG. 3. FIG. 1 is a block diagram showing the main structure of the system in the present invention and FIG. 3 shows the main structure of the system in the present invention. The system in the present invention comprises: a control center (1) having a main control program (11); a virtual machine (2) of a GPS receiver; a GPS receiver (3) on every moving target (31); wireless communication device (4); wire/wireless internet (5); and a map-containing navigation device (6).

The advantages of the system in the present invention are summarized as follows:

1. The GPS receiver with each traced target can be separately positioned in the place different from the navigation device.

2. The system can use a main unit to monitor multiple targets simultaneously.

3. A set of the map-containing navigation device can be applicable to all targets. The positions of the targets are displayed on the map for tracing, positioning, and navigating.

4. The information received by the GPS receiver in the target is transmitted to the virtual machine of the GPS receiver and to the navigation device for recognizing the confirmed position of every target as well as processing the tracing, positioning, and navigating functions.

### BRIEF DESCRIPTION OF THE DRAWINGS

The structure, purpose, method and spirit of the present invention can be best understood through the following description and the accompanying drawings wherein:

FIG. 1 is a block diagram showing the main structure of the system in the present invention;

FIG. 2 is a block diagram showing the operational theory of the system in the present invention;

FIG. 3 shows the main structure of the system in the present invention;

FIG. 4 shows a block diagram reactive between the GPS receiver and the map-containing navigation device; and

FIG. 5 is a block diagram showing the theory of the conventional navigation system.

### DETAILED DESCRIPTION OF THE INVENTION

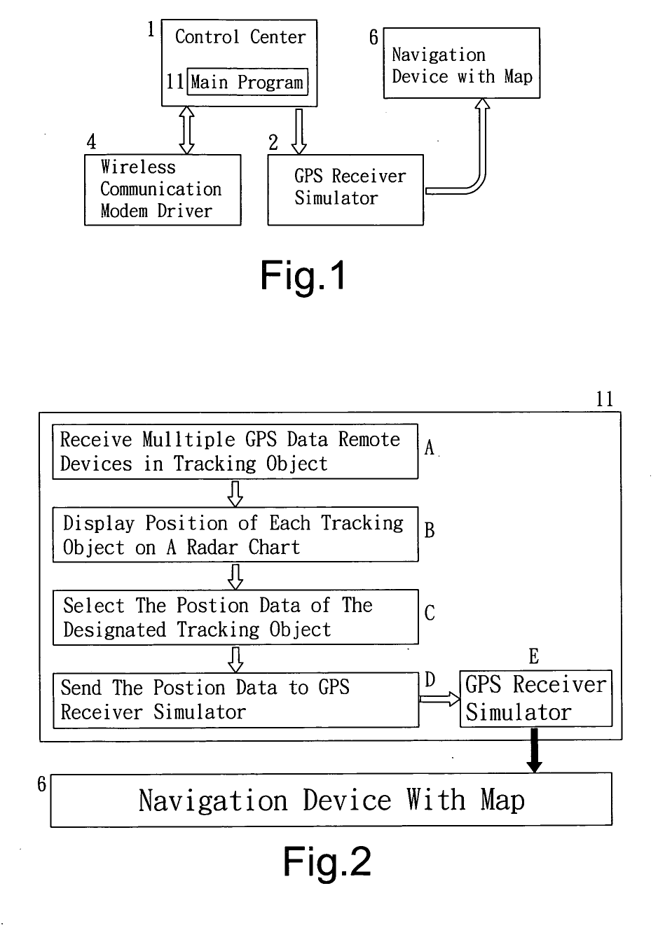

Please refer to FIG. 1 and FIG. 3. FIG. 1 is a block diagram showing the main structure of the system in the present invention and FIG. 3 shows the main structure of the system in the present invention. Multiple GPS receivers (3) are separately positioned in each moving target (31), for example, every transportation vehicle or important shipping product in the transportation company. After every GPS receiver (3) receives the satellite signal and obtains the longitude/latitude coordinates, the information is transmitted by the wireless communication device (4) thru wireless communication network (5) to the control center (1) having the main control program (11).

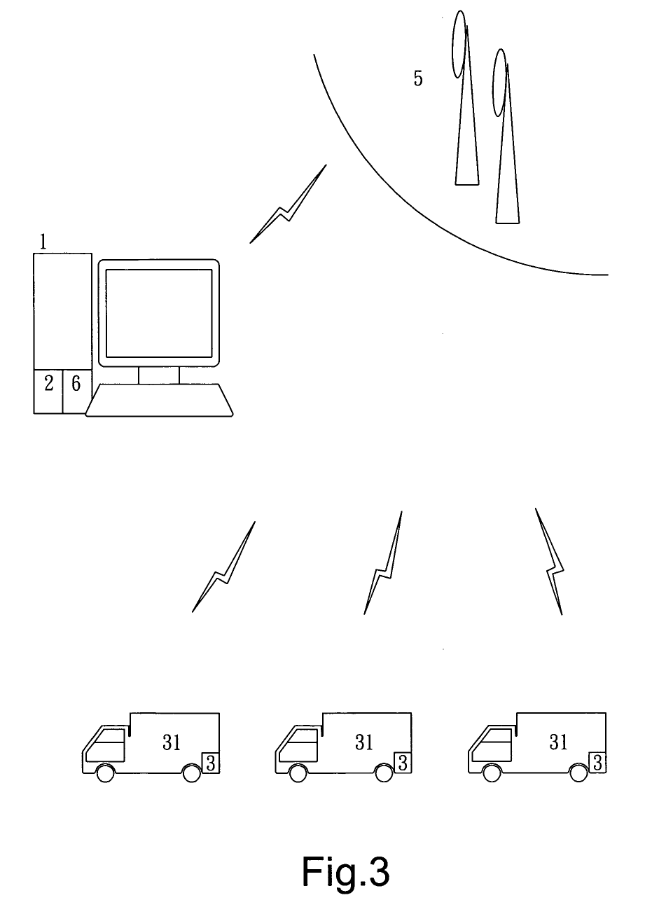

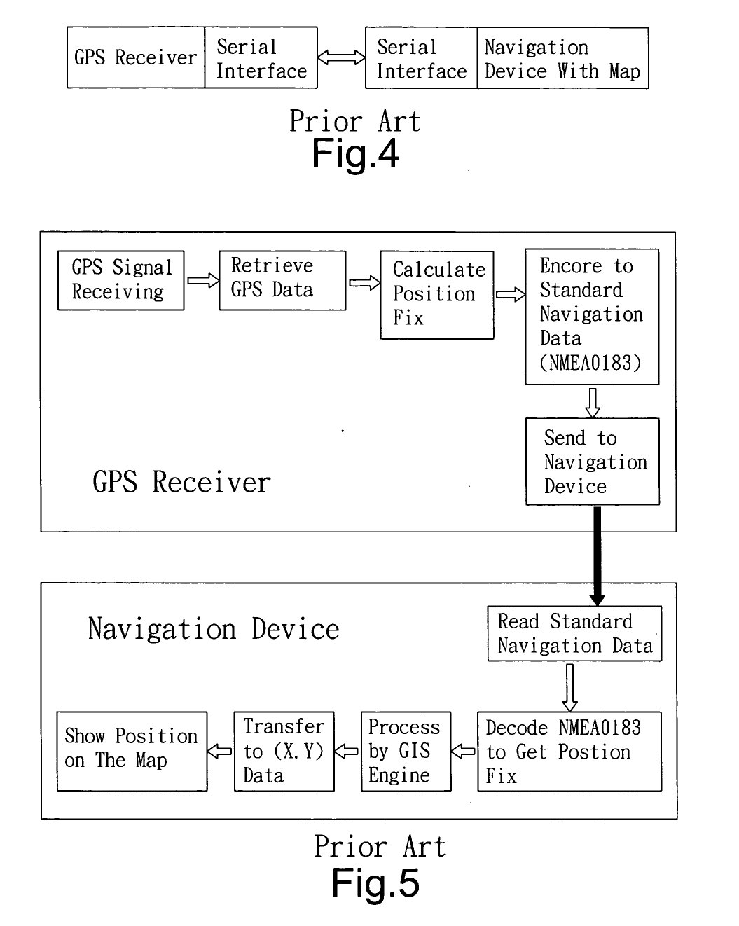

As can be seen from FIG. 2, it is a block diagram showing the operational theory of the system in the present invention. The main control program (11) of the control center (1) receives the satellite information (A) from GPS receiver (3) in each target (31) thru wireless communication network (5). The main control program (11) uses the radar diagram of the control center (1) to display the positions of the traced targets with bright dots (B). The user can select one target (31, C) from the display of the control center (1). In the meantime, the positioning information of the target (31) is transmitted to the virtual machine (2, D) of the GPS receiver. The virtual machine (2) of the GPS receiver sends the information to the map-containing navigation device (6, E). After the related information is processed by the map-containing navigation device (6), the map in the display of the control center (1) can display the accurate position for each target (31). Further, the map-containing navigation device (6) can process other functions.

According to the above descriptions, the present invention can enhance and expand the current navigation device for further functions and applications. Moreover, the virtual machine (2) of the GPS receiver can operate the map-containing navigation device to use in multiple GPS receivers simultaneously. The general navigation device, therefore, can be further expanded for tracing and positioning the targets.

The above embodiments are only used to illustrate the present invention, and are not intended to limit the scope thereof. Many modifications of the above embodiments can be made without departing from the spirit of the present invention.

What is claimed is:

1. A GPS navigation enhanced system comprises:
a control center (1) having a main control program (11);
a virtual machine (2) of a GPS receiver;
multiple GPS receivers (3) having multiple moving targets;
a wireless communication device (4); and
a map-containing navigation device (6);
wherein said multiple GPS receivers (3) separately positioned in one of the moving targets (31); after every GPS receiver (3) receiving the satellite signal and obtaining the longitude/latitude information, the said information transmitted by the wireless communication device (4) thru wireless communication network (5) to the control center (1) having the main control program (11); wherein the positions of said targets displayed in the display of said control center (1); wherein the positioning information of said target (31) transmitted to said virtual machine (2) of the GPS receiver and said map-containing navigation device (6); wherein said map-containing navigation device (6) processing other functions.

2. A GPS navigation enhanced system according to claim 1, wherein said map-containing navigation device (6) and said GPS receiver (3) can be separately positioned in the GPS navigation system.

3. A GPS navigation enhanced system according to claim 1, wherein said virtual machine (2) of the GPS receiver can operate a set of the map-containing navigation device (6) to use in multiple GPS receivers (3) simultaneously.

4. A GPS navigation enhanced system according to claim 1, wherein said map-containing navigation device can be used as tracing, positioning or other purposes.
